(19) United States
(12) Patent Application Publication
(10) Pub. No.: US 2020/0293107 A1
(43) Pub. Date: Sep. 17, 2020

(54) METHOD AND SYSTEM FOR REALIZING CHARACTER INPUT BY MEANS OF EYE MOVEMENT

(71) Applicant: Anadolu Universitesi, Eskisehir (TR)

(72) Inventors: Cihan TOPAL, Eskisehir (TR); Burak BENLIGIRAY, Eskisehir (TR)

(21) Appl. No.: 16/086,052

(22) PCT Filed: Aug. 31, 2016
(86) PCT No.: PCT/TR2016/050318

§ 371 Date: Sep. 18, 2018

(30) Foreign Application Priority Data
Mar. 18, 2016 (TR) 2016/03526

(51) Int. Cl. G06F 3/01; G06F 3/0488; G06F 40/274

(52) U.S. Cl. CPC G06F 3/013; G06F 40/274; G06F 3/04886

(57) ABSTRACT

The present invention is a computer-based character input method in order to provide the user to type by means of eye (6) movements, where, an on-screen keyboard interface (2), comprising the key segments (21) accommodating at least one typing character, is presented to a display unit (5), the typing character, provided in the key segment (21) corresponding to the point where the eye (6) gazes at the display unit (5), is selected and presented to the user in accordance with the data taken from an eye tracking device (1) which senses the eye (6) position of the user gazing at said display unit (5).

### TECHNICAL FIELD

The present invention relates to a computer-based character input method and system for realizing said method where an on-screen keyboard interface, comprising key segments accommodating at least one typing character for providing the user to make typing by means of eye movements, is presented in a display unit, and where the typing character, provided in the key segment corresponding to the point on the display unit where the eye gazes at, is selected and presented to the user, in accordance with the data received from an eye tracking device which senses the position of the eye of the user gazing at said display unit.

### PRIOR ART

Typing by means eye movement is one of the most important needs of particularly physically-disabled and paralyzed persons. Typing by means of eye movement is based on the interaction of the user with the computer by utilizing the point where the eye gazes on a screen by means of an image sensor directed to the eye.

Various systems are provided for typing by means of the eye. In the patent US2012086645, a system is disclosed where the frequently used words are arranged on a ring around a center and where the system uses an on-screen keyboard interface where the frequently used letters are provided on another ring inside said ring.

Eye tracking systems do not work as robust as the computer mouse. Due to reasons like the point gazed at, the sensitivity of the system used, light conditions, detection cannot be realized in an exact manner, and accordingly, convergence is made by means of any method. This leads to a jitter in the pointer location during the tracking. When a physical hardware which will realize the selection is not used, the user gazes at the target key for a specific duration, and the selection is realized. Particularly while small screen devices like mobile device, tablet are used, since the character amount is fixed and since the sizes of the characters on the screen are fixed, it becomes difficult to wait the pointer on the same key by the user due to the above mentioned technical problem.

As a result, because of all of the abovementioned problems, an improvement is required in the related technical field.

### BRIEF DESCRIPTION OF THE INVENTION

The present invention relates to method and system for realizing character input by means of eye movement, for eliminating the above mentioned disadvantages and for bringing new advantages to the related technical field.

The main object of the present invention is to provide method and system for realizing character input where the wrong character selections occurring due to the jitters which occur during character selection or the delays in character selection are reduced.

Another object of the present invention is to provide method and system for realizing character input where the speed of reaching the target character is increased.

Another object of the present invention is to provide method and system for realizing character input where the speed of word and character series typing is increased.

Another object of the present invention is to provide method and system for realizing character input where the amount of being affected due to the jitter occurring during character selection is reduced.

In order to realize all of the abovementioned objects and the objects which are to be deducted from the detailed description below, the present invention is a computer-based character input method in order to provide the user to type by means of eye movements, where,

an on-screen keyboard interface, comprising the key segments accommodating at least one typing character, is presented to a display unit,
the typing character, provided in the key segment corresponding to the point where the eye gazes at the display unit, is selected and presented to the user in accordance with the data taken from an eye tracking device which senses the eye position of the user gazing at said display unit. Accordingly, the improvement of the subject matter invention is that the user selects at least one character and forms a character series and afterwards, a word database is accessed comprising pre-recorded words,
in accordance with said word database; the letters, of which the frequency of use after the selected character series is greater than a predetermined value, are determined as a first group, and the letters, of which the frequency of use after the selected character series is lower than a predetermined value, are determined as a second group and thereby at least two groups are formed,
the key segments comprising the characters provided in the second group are at least partially narrowed,
the key segments comprising the characters provided in the first group are at least partially widened. Thus, the sizes of the letters, of which the probability of use is high, on the on-screen keyboard interface are increased; and the effect of lighting problems or the effect of jitters occurring during determination of the gazing location by means of the convergence methods used in cases of insufficient sensitivity equipment usage is reduced.

In a preferred embodiment of the subject matter invention, the key segments, comprising the characters provided in the second group, are removed from the on-screen keyboard interface.

In another preferred embodiment of the subject matter invention, at least one of the key segments, comprising the characters provided in the first group, is widened in a manner filling the areas emptied by the second group key segments removed from the on-screen keyboard interface.

In another preferred embodiment of the subject matter invention, in case the words input by the user are not existing in the word database, said word is recorded in the word database, and in case the words input by the user are existing in the word database, a usage frequency value is assigned to the selected word, and if the usage frequency value is already present, this usage frequency value is updated. Thus, the words selected by the user are recorded and they can be presented to the user in the future as primary recommendation.

In another preferred embodiment of the subject matter invention, in case one of the key segments comprising the characters provided in the first group is selected, after the pre-selected character series, a recommended word, of which the usage frequency is higher than a predetermined value with respect to a collection provided in the word database and comprising the character in this key segment, is added to the key segment. Thus, the user can select a recommended word without making additional eye movement. Moreover, excessive place occupation on the screen for the recommended word is prevented.

In another preferred embodiment of the subject matter invention, in case the user gazes at the key segment, comprising the recommended word, for duration longer than the predetermined duration, the recommended character series inside the key segment is selected and the selected character series is presented visually to the user.

### BRIEF DESCRIPTION OF THE FIGURES

FIG. 1 is a representative view of the subject matter system.

FIG. 2 is a representative and detailed view of the processor unit.

FIGS. 3a, 3b and 3c are representative views of the on-screen keyboard interface.

### REFERENCE NUMBERS

1 Eye tracking device
2 On-screen keyboard interface
   21 Key segment
   22 Keyboard body
   221 Center area
   222 First ring area
   223 Second ring area
3 Processor unit
4 Memory unit
   40 Word database
   41 On-screen keyboard module
   42 Data receiving module
   43 Segment determination module
   44 Segment selection module
   45 Typing module
   46 Grouping module
   47 Sizing module
   48 Recommendation module
   49 Record module
5 Display unit
6 Eye

### THE DETAILED DESCRIPTION OF THE INVENTION

In this detailed description, the subject matter system and method is explained with references to examples without forming any restrictive effect only in order to make the subject more understandable.

The character/typing character mentioned in this detailed description covers the letters and marks used in typing. The character series describes bringing together pluralities of characters. Incomplete words, syllables, abbreviations can be shown as an example to the character series.

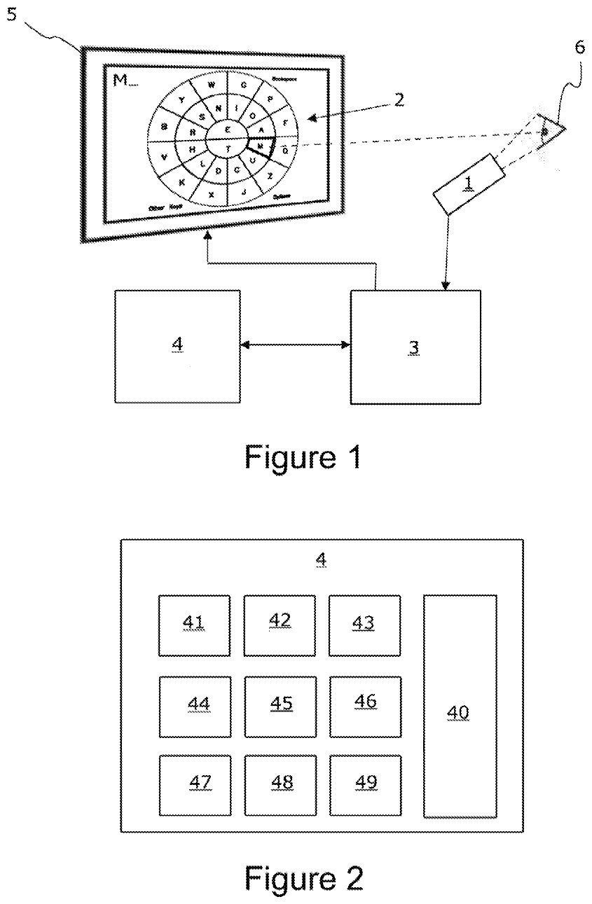

With reference to FIG. 1, the system in said exemplary application comprises an eye tracking device (1) displaying the eye (6) of the user, a processor unit (3) evaluating the data received from the eye tracking device (1), a memory unit (4) connected to the processor unit (3), a display unit (5), and an on-screen keyboard interface (2) formed by the processor unit (3) on the display unit (5).

The processor unit (3) can be any general or special purpose processor. The memory unit (4) may comprise RAM, ROM, magnetic or optical hard disc or any data storage device combination which can be read by computer.

The operation of the system is realized by means of pluralities of functional modules placed in the memory unit (4) and formed by command sets executed by the processor unit (3).

The eye tracking device (1) is configured so as to sense the position of an eye (6) of the user and so as to transfer the related data to the processor unit (3) at specific periods. In more details, the eye tracking device (1) is a system comprising software and hardware which process the information obtained from the eye (6) and the periphery thereof by means of the sensors thereof and which measure the examined point or the activity of eye (6).

In an exemplary application, the eye tracking device (1) may be a camera. In another exemplary application, the eye tracking device (1) may comprise scleral searching coil positioned in the periphery of the eye (6) and which transfers the changes formed by eye (6) movements to the processor unit (3). Again, in an exemplary application, the eye tracking device (1) may comprise sensors configured for sending the position of the eye (6) by means of electro-oculography. In a possible application, the eye tracking device (1) may comprise light sensitive sensors and hardware comprising the suitable configurations of these sensors, and software which supports this. The subject matter character inputting method is described through an exemplary application where the eye tracking device (1) is a camera.

The display unit (5) is a screen which may present the images, formed by the processor unit (3), to the user visually.

The memory unit (4) comprises an on-screen keyboard module (41), a data receiving module (42), a segment determination module (43), a segment selection module (44), a typing module (45), a grouping module (46), a sizing module (47), a recommendation module (48) and a record module (49).

In order to provide the user to realize typing by means of gazing at the screen, the system, of which the details are described above, functions as follows: The processor unit (3) transfers an on-screen keyboard interface (2), formed by means of the on-screen keyboard module (41), to the display unit (5) in order to be presented to the user.

In the preferred embodiment, the on-screen keyboard interface (2) comprises key segments (21). The key segments (21) accommodate typing characters therein. Said key segments (21) are brought together and they form a keyboard body (22). In the preferred embodiment, the keyboard body (22) has a circular form. The typing characters are placed such that the frequently used ones are placed close to the center and the rarely used ones are placed outwardly from the center in accordance with the degree of the usage frequency. At the center of the keyboard body (22), a circularly formed center area (221) is defined. There is at least one key segment (21) at the center area (221). At the periphery of the center area (221), a first ring area (222) is defined which encircles the center area (221). Inside the first ring area (22), there are key segments (21) arranged at equal distances with respect to the center area (221). In the region defined as a second ring area (223) and encircling the first ring area (222), there are key segments (21) arranged in equal distances with respect to the center area (221). There is a character in each key segment (21). Said characters show difference in accordance with the languages, and they are placed in accordance with their usage frequencies. As the frequently used characters are placed close to the center, the speed of reaching of the user to the target characters is increased.

A word database (40) in the memory unit (4) may comprise pre-recorded words. Said word database (40) may moreover accommodate the collections formed for different languages. Said collections may also comprise words and they may also comprise the word groups formed by bringing pluralities of words one after the other. Besides, the word database (40) may also comprise the words entered by the user by means of the on-screen keyboard interface (2) and the usage frequencies related to these.

In more details, the processor unit (3) comprises a data receiving module (42). The data receiving module (42) receives the images, coming from the eye tracking device (1), at specific periods.

The segment determination module (43) determines the point on the display unit (5) gazed at by the user in accordance with the position of the eye (6), and the key segment (21) corresponding to this point. The character, provided in the determined key segment (21), is colored such that the user visually detects it, in order to be presented to the user. In a possible embodiment, there may be a pointer at the gazing location of the user, and this pointer may move by means of the movements of the eye (6) of the user.

In case the user gazes at a key segment (21) at a predetermined duration (in case predetermined amount of screen point marks the same key segment (21)), the segment selection module (44) selects the key segment (21) and the character in it. The selected character is typed to the image unit (5) by a typing module (45).

The grouping module (46) searches the selected typing character or the words comprising the character series formed by the selected character in the word database (40). This search is in the form of searching the words comprising character series selected in a sequenced manner as from the beginning. After the selected character series in the word database (40), the characters, placed at a predetermined frequency, are grouped as a first group, and the letters, which are not placed after the selected character series or placed at a lower frequency when compared with predetermined frequency, are grouped as a second group. In other words, the letters, which are highly probable to be selected by the user, are provided in the first group, and the letters, which are not highly probable to be selected by the user, are provided in the second group. This grouping can also be made by increasing the group numbers or by means of different methods. This grouping may be any method which recommends the next character to the user by comparing the character series input by the user or the words which may be formed by this character series. In the art, there are pluralities of methods which recommend characters or words to the user.

For instance, let us assume that a first character and a second character have been selected. Let us assume that the number of words, comprising the first and second characters sequentially as from the beginning and afterwards the third character, is 100. Let us assume that the number of words, comprising the first and second characters sequentially as from the beginning and afterwards the fourth character, is 0. In this case, since the probability of the user to select the third character after the first and second character is higher, the first character is provided in the first group and the fourth character is provided in the second group. This grouping may change depending on the usage frequency of the words in the language in accordance with the collection, the usage frequency by the user or the words input by the user beforehand.

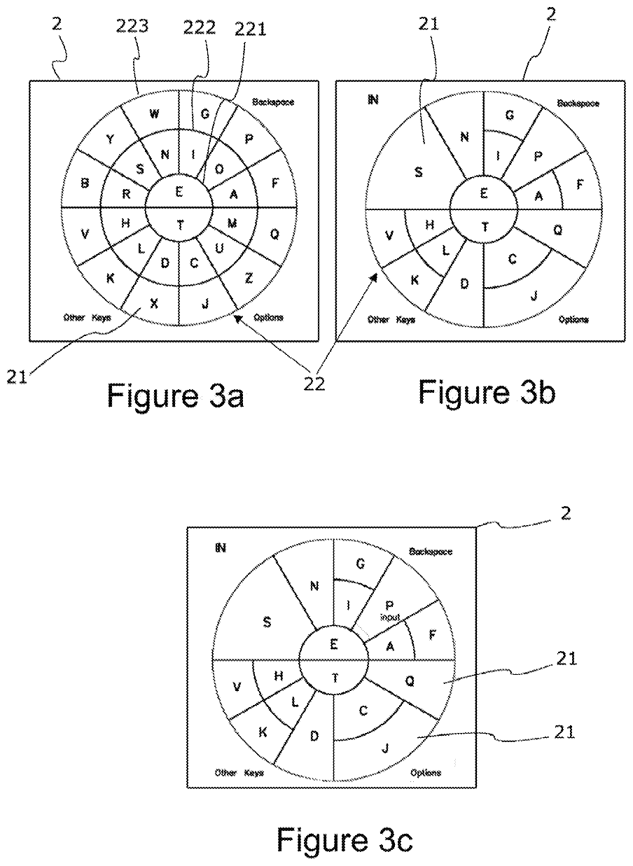

The sizing module (47) re-sizes the key segments (21) of the letters, separated into groups, on the on-screen keyboard interface (2). In a possible embodiment, the key segments (21), comprising the characters provided in the second group, are lost. The key segments (21), comprising the characters provided in the first group, are widened towards the regions emptied by the key segments (21) comprising the characters provided in the adjacent second group. In alternative embodiments, the groups with different numbers may change in accordance with the characters used at different frequencies. For instance, if the letters, used frequently, less frequently and rarely, are separated into 3 different groups, the letters used rarely may be erased by means of the on-screen keyboard interface (2) together with the key segments (21); while the key segments (21) of the characters used less frequently are kept fixed, the key segments (21) of the characters used frequently may be widened towards the key segments (21) of the erased characters. In another embodiment, the key segments (21) comprising the frequently used characters which do not have adjacent erased key segment (21) may be kept fixed. As a result, while the key segment (21) areas, classified so as to have a higher usage probability after the character series selected from the characters separated into at least two groups, are widened, the key segment (21) areas of the letter characters classified so as to have a lower usage probability are at least partially narrowed, and when required, they are completely erased. In FIG. 3a, the form of the on-screen keyboard interface (2), where any typing character selection has not been made, is illustrated. On the view of the on-screen keyboard interface (2) illustrated in FIG. 3b, the selection of the “IN” character series has been realized. The ones which are not much probable to be selected as a next typing character have been erased, in other words, in the words provided in the word database (40), the typing characters (for instance, Y, B, R), of which the application amount of the “IN” character series is substantially lower than the predetermined values, have been erased, and the key segments (21) accommodating the typing characters have been erased. In the word database (40), the key segments (21) of the letter characters (for instance, S), of which the application amount thereof is substantially higher than the predetermined values, have been widened towards the areas of the key segments (21) of the erased letter characters. The key segments (21) of the typing characters (for instance, V, H, L, K), of which the application amount after the “IN” character series is close to the predetermined value, have been kept in the same size, in other words, the key segments (21) of the typing characters, provided between the ones which are highly probable and the ones which are not highly probable to be applied after the “IN” character series, have been kept in the same size.

The recommendation module (48) adds a recommended word, which may be obtained by means of the character series formed by the finally selected letter character, to the key segment (21) of the selected character. When a predetermined duration is waited once more on the selected character, the word provided inside the key segment (21) of the selected character, is accepted as selected, and the typing module (45) realizes the presentation process, in other words, the typing process of the selected word on the screen. For instance, following FIG. 3b, when the P typing character is waited during a predetermined duration after the “IN” character series in FIG. 3c, the typing character P is selected. When the typing character P is added to the character series “IN” into the key segment (21) of the typing character P, the word “INPUT”, which is most highly probable to be formed, is added. Also in case the user gazes at the key segment (21) of the typing character P for a predetermined duration, the word “INPUT” is selected. After a word is selected, if the word, of which a record module (49) is selected, is a word which has not been used beforehand, the word is recorded to the database (40). If the selected word is a pre-used word, the word database (40) is updated such that the recommendation priority increases after the selected preamble.

As a result, in case the on-screen keyboard interface (2) has a circular form and the frequently used typing characters are placed close to the center of the keyboard body (22), the user can realize passage between the typing characters in a more rapid manner. In accordance with the Fitts's law, during the interaction of the user with a computer, the duration of reaching the target is a function depending on the distance of the target and the size of the object. The placement of frequently used typing characters to the center of the keyboard body (22) provides the distance of the target typing characters with respect to the beginning point of the user's glance to be shorter when compared with the identical on-screen keyboards. Moreover, the reduction of the key segments (21) of the typing characters, which are not probable to be used under normal conditions or which have very low probability to be used, increases the speed of reaching the target character by means of widening of the key segments (21) comprising typing characters which have high probability to be used after the selected character series.

The protection scope of the present invention is set forth in the annexed Claims and cannot be restricted to the illustrative disclosures given above, under the detailed description. It is because a person skilled in the relevant art can obviously produce similar embodiments under the light of the foregoing disclosures, without departing from the main principles of the present invention.

1-6. (canceled)

7. A computer-based character input method in order to provide the user to type by means of eye movements, where,
an on-screen keyboard interface, comprising the key segments accommodating at least one typing character, is presented to a display unit,
the typing character, provided in the key segment corresponding to the point where the eye gazes at the display unit, is selected and presented to the user in accordance with the data taken from an eye tracking device which senses the eye position of the user gazing at said display unit, said method is characterized in that a word database is accessed comprising pre-recorded words,
a circularly formed center area comprising at least one key segment, having a typing character which has a frequency of occurring in said word database is greater than a predetermined value, is presented to said display unit,
at least a first ring area which encircles said center area comprising pluralities of key segments each having one typing character, each typing character having a frequency of occurring in the word database greater than the typing characters in center area, is further presented to said display unit,
the user selects at least one character and forms a character series and afterwards, the word database is accessed,
in accordance with the word database; the letters, of which the frequency of use after the selected character series is greater than a predetermined value, are determined as a first group, and the letters, of which the frequency of use after the selected character series is lower than a predetermined value, are determined as a second group and thereby at least two groups are formed,
the key segments, comprising the characters provided in the second group, are removed from the on-screen keyboard interface,
the key segments comprising the characters provided in the first group are at least partially widened.
at least one of the key segments, comprising the characters provided in the first group, is widened in a manner filling the areas emptied by the second group key segments removed from the on-screen keyboard interface.

8. A character inputting method according to claim 7, characterized in that in case the words input by the user are not existing in the word database, said word is recorded in the word database, and
in case the words input by the user are existing in the word database, a usage frequency value is assigned to the selected word, and if the usage frequency value is already present, this usage frequency value is updated.

9. A character inputting method according to claim 7, characterized in that in case one of the key segments comprising the characters provided in the first group is selected, after the pre-selected character series, a recommended word, of which the usage frequency is higher than a predetermined value with respect to a collection provided in the word database and comprising the character in this key segment, is added to the key segment.

10. A character inputting method according to claim 9, characterized in that in case the user gazes at the key segment, comprising the recommended word, for a duration longer than the predetermined duration, the recommended character series inside the key segment is selected and the selected character series is presented visually to the user.
